(19) United States
(12) Patent Application Publication
(10) Pub. No.: US 2015/0033992 A1
(43) Pub. Date: Feb. 5, 2015

(54) CONCRETE SAW RACK HAVING SLOT TO ACCOMMODATE BLADE

(71) Applicant: Marriott Construction, Inc., Waukesha, WI (US)

(72) Inventor: James R. Marriott, Hartland, WI (US)

(73) Assignee: Marriott Construction, Inc., Waukesha, WI (US)

(21) Appl. No.: 14/374,142

(22) PCT Filed: Jan. 23, 2013
(86) PCT No.: PCT/US13/22693

§ 371 Date: Jul. 23, 2014

Related U.S. Application Data
(60) Provisional application No. 61/589,861, filed on Jan. 23, 2012.

(51) Int. Cl. B65D 19/00; B65D 85/68; B65D 19/44; B28D 1/04

(52) U.S. Cl. CPC B65D 19/0026; B28D 1/04; B65D 85/68; B65D 19/44
USPC 108/50.11

(57) ABSTRACT

A transportation system for a concrete saw includes an opening in a support surface for the concrete saw. The opening in the support surface is positioned and sized to receive the saw blade while the concrete saw is supported by the support surface. The transportation system is adapted to be loaded on a transporter for transportation of the construction equipment.

### BACKGROUND

The present invention relates to a transportation rack that includes a slot to accommodate the blade of a piece of construction equipment, such as a concrete saw.

### SUMMARY

The invention provides a transportation system for a concrete saw, the concrete saw including at least one wheel for rolling over a concrete surface to be cut, and a saw blade extending below the at least one wheel and adapted to cut the concrete surface, the transportation system comprising: a frame including a support surface; and an opening in the support surface; wherein the support surface is adapted to support the concrete saw with the wheel on the support surface; wherein the opening in the support surface is positioned and sized to receive the saw blade while the concrete saw is supported by the support surface; and wherein the transportation system is adapted to be loaded on a transporter for transportation of the construction equipment.

In some embodiments, the at least one wheel of the concrete saw includes a smooth, hard wheel that supports the saw during operation, the transportation system further comprising: a pad supported by the support surface of the frame and supporting the smooth wheel of the construction equipment, the pad absorbing a dynamic load arising during transport. In some embodiments, the transportation system further comprises: a rigid guard mounted to the frame along at least a portion of the opening and extending upwardly from the support surface, the rigid guard shielding the saw blade during transport. In some embodiments, the transportation system further comprises: a restraining mechanism adapted to limit movement of the concrete saw during transport. In some embodiments, the restraining mechanism includes first and second support struts mounted to the frame on opposite sides of the frame and adapted to extend upwardly on opposite sides of the concrete saw, and a rigid bar extending between the support struts. In some embodiments, the restraining mechanism includes a strap having at least one end anchored to the frame. In some embodiments, the strap includes an opposite end also anchored to the frame, the strap extending across the concrete saw. In some embodiments, the restraining mechanism also includes a winch acting on the strap. In some embodiments, the frame includes an anchor and the strap includes a hook for engaging the anchor. In some embodiments, the transportation system further comprises a ramp pivotally mounted to the frame and movable into a deployed condition to facilitate moving the concrete saw onto the frame and a stowed condition; male and female clevises on the frame and ramp; and a hinge pin extending through the male and female devises to pivotally mount the ramp to the frame. In some embodiments, the ramp is within the footprint of the frame when in the stowed condition. In some embodiments, the transportation system further comprises a lifting device interface adapted to receive portions of a lifting device to facilitate loading and unloading the transportation system onto and off of the transporter. In some embodiments, the lifting device interface includes a pair of fork lift tubes.

Other aspects of the invention will become apparent by consideration of the detailed description and accompanying drawings.

### BRIEF DESCRIPTION OF THE DRAWINGS

FIG. 1 is a perspective view of a transportation rack according to a first embodiment of the present invention, bearing a piece of construction equipment.

FIG. 2 is a perspective view of the transportation rack of FIG. 1 from another perspective with the construction equipment removed.

FIG. 3 is a top view of the transportation rack with the pad removed for illustrative purposes.

FIG. 4 is an enlarged view of the vertical struts and rigid bar of the transportation rack.

FIG. 5 is an enlarged view of the ramp in a deployed condition.

FIG. 6 is a perspective view of a transportation rack according to a second embodiment of the present invention, bearing another piece of construction equipment.

FIG. 7 is a perspective view of the transportation rack of FIG. 6 with the construction equipment removed.

FIG. 8 illustrates a lifting apparatus lifting the transportation rack and construction equipment for deposit into a transporter.

FIG. 9 is a side view of a transportation rack according to a third embodiment of the present invention, bearing another piece of construction equipment.

FIG. 10 is a perspective view of the third embodiment.

FIG. 11 is a top view of the third embodiment.

FIG. 12 is a side view of the third embodiment with the ramp deployed.

FIG. 13 is an end view of the third embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The present invention provides a transportation rack for a piece of construction equipment of a type having a smooth, hard wheel that supports the construction equipment during operation, a precisely-aligned element, a prime mover, and a drive train for driving the smooth wheel under the influence of the prime mover to propel the construction equipment during operation.

The term “hard wheel,” as used in the present specification, refers to a wheel that includes a hub constructed of rigid materials, such as steel or other metal. The smooth surface around the hard wheel is provided, for example, by a ring of hard rubber. The hard rubber may be referred to as a tire, but is different from traditional tires in that it is not necessarily inflated and provides a substantially unyielding smooth surface. The term “smooth, hard wheel” is intended to include both the hard wheel and the hard rubber tire around the hard wheel, the resulting combination providing a substantially unyielding smooth round surface on which the construction equipment rides.

The smooth, hard wheel can develop a flat spot in response to an external load being applied to the construction equipment in excess of a wheel damage threshold. The precisely-aligned element can be misaligned in response to an external load applied to the precisely-aligned element in excess of a misalignment threshold. The drive train is subject to damage in response to an external load being applied to the construction equipment in excess of a drive damage threshold. The term “external load” means a load in excess of loads that are present during ordinary operation of the construction equipment. For example, the weight of the construction equipment is a load borne by the smooth wheel during ordinary operation, and would not be an “external load” as that term is used herein.

The term “precisely aligned,” as used in this specification, means that successful use of the construction equipment relies on such element being maintained in alignment with respect to another element of the construction equipment. Misalignment of the precisely-aligned element refers to movement of the precisely-aligned element out of alignment with the other element. Should the precisely-aligned element become misaligned, the construction equipment will fail an essential purpose.

An example of a piece of construction equipment for which the transportation rack of the present invention is suitable is a class of concrete saws called “early entry” saws. Early entry saws are adapted to cut a straight line in green-state (i.e., still curing and hardening) concrete. One specific, commercially-available concrete saw of this type is the SOFF-CUT early entry saw manufactured and sold by Husqvarna. Although the accompanying drawings illustrate an early entry saw, it is to be understood that the present invention may accommodate other types of concrete saw and is not limited to early entry saws.

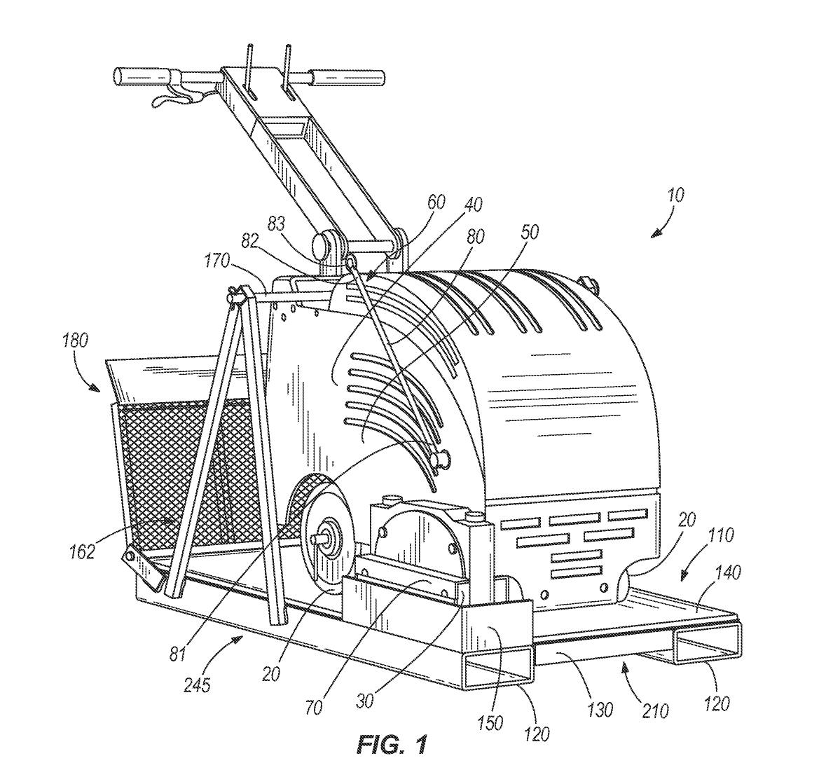

FIG. 1 illustrates an exemplary concrete saw 10. The concrete saw 10 includes a pair of smooth, hard wheels 20, a precisely-aligned element in the form of a cutting blade chuck 30, a prime mover in the form of an electric motor 40, a drive train 50, and a line guide 60. The smooth, hard wheels 20 permit the concrete saw 10 to roll over green-state concrete without marring the smooth surface. A circular cutting blade 70 may be mounted to the cutting blade chuck 30, and the cutting blade chuck 30 and cutting blade 70 are rotated under the influence of the electric motor 40. In other embodiments the prime mover can be an internal combustion engine or any other suitable prime mover. The drive train converts torque of the electric motor into rotation of the smooth, hard wheels.

The line guide 60 includes a bar 80 having a first end 81 pivotably mounted to the right side of the saw 10 and a second end 82 opposite the first end 81, and a disk 83 rotatably mounted to the second end 82 of the bar 80. In operation, the line guide 60 is pivoted into an operational position in which the first end 81 of the bar 80 is in front of the cutting blade chuck 30, and the disk 83 is resting on the concrete to be cut. As the saw 10 moves forward, the disk 83 rolls along the concrete to define a cutting line. The cutting blade chuck 30 is precisely aligned with the line guide 60, such that the saw blade 70 cuts into the concrete a kerf that is collinear with the cutting line. In this regard, the line guide 60 is another element of the concrete saw 10 with which the cutting blade chuck 30 (i.e., the precisely-aligned element) is aligned.

FIGS. 1-3 illustrate a transportation rack or transportation system 110 for the illustrated concrete saw 10. The transportation system 110 includes a pair of tubes 120, a plurality of inner brace members 130, a pad 140, a rigid guard 150, first and second support struts 161, 162, a rigid bar 170, a ramp 180, and a latch 190.

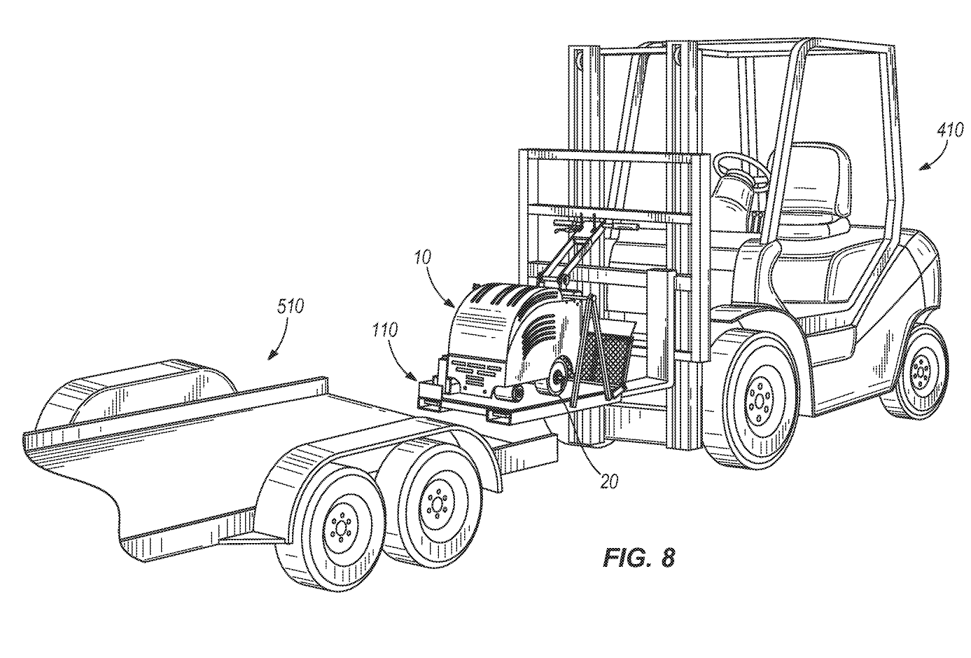

The pair of tubes 120 extend from a front end 210 of the rack 110 (where the rigid guard 150 is) to a rear end 220 of the rack 110 (wherein the ramp 180 is mounted), and define left and right sides 230, 240 of the rack 110. The plurality of inner brace members 130 extend between the pair of tubes 120 and are rigidly mounted (e.g., as by welding) to the pair of tubes 120. In this regard, the pair of tubes 120 and the inner brace members 130 define a frame 245 for the rack 110. The pair of tubes 120 and inner brace members 130 also define a support surface 250. The pair of tubes 120 define a lifting device interface, as will be discussed below with reference to FIG. 8.

The pad 140 is supported by the support surface 250 of the frame. The pad 140 supports the smooth wheels 20 of the concrete saw 10. In the illustrated embodiment, the pad 140 is about one half inch (½″) thick and is constructed of thick rubber. One example of a suitable pad is the ‘½″ Thick Trailer Mat manufactured of recycled materials by Humane Manufacturing Company LLC of Baraboo, Wis.

The rigid guard 150 is mounted to the frame 245 for protecting the cutting blade chuck 30 during transport at least to the extent of any impacts in excess of the misalignment threshold. The rigid guard 150 protects the cutting blade chuck 30 from, for example, debris that fly at the cutting blade chuck 30 during transport, and from any items carelessly thrown into the area where the transportation rack 110 is secured in the transportation vehicle or trailer (collectively, “transporter”).

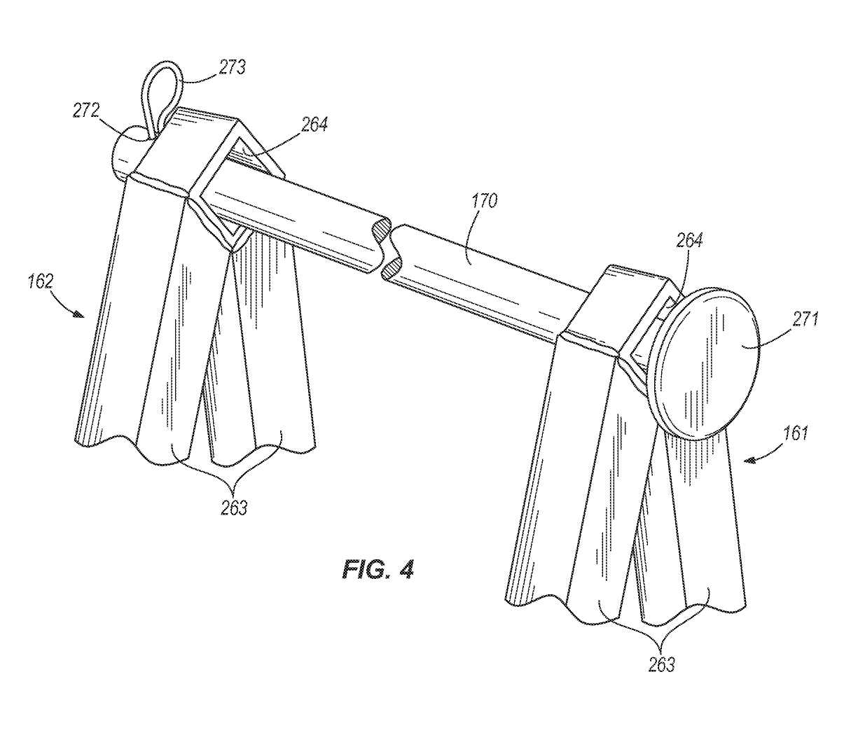

Referring to FIG. 4, the first and second support struts 161, 162 are mounted to opposite sides of the frame 245 and extend upwardly on opposite sides of concrete saw 110. Each support strut 161, 162 includes a pair of legs 263 which define a triangle with the tubes 120, and an aperture 264 where the pair of legs 263 meet at the top of the support struts 161, 162. The rigid bar 170 includes a first end that has an enlarged knob 271 and a second end that includes a retaining hole 272 for accommodating a cotter pin 273 or other retainer. If the arrangement of the concrete saw 10 permits, the rigid bar 170 may extend through a portion of the concrete saw 10.

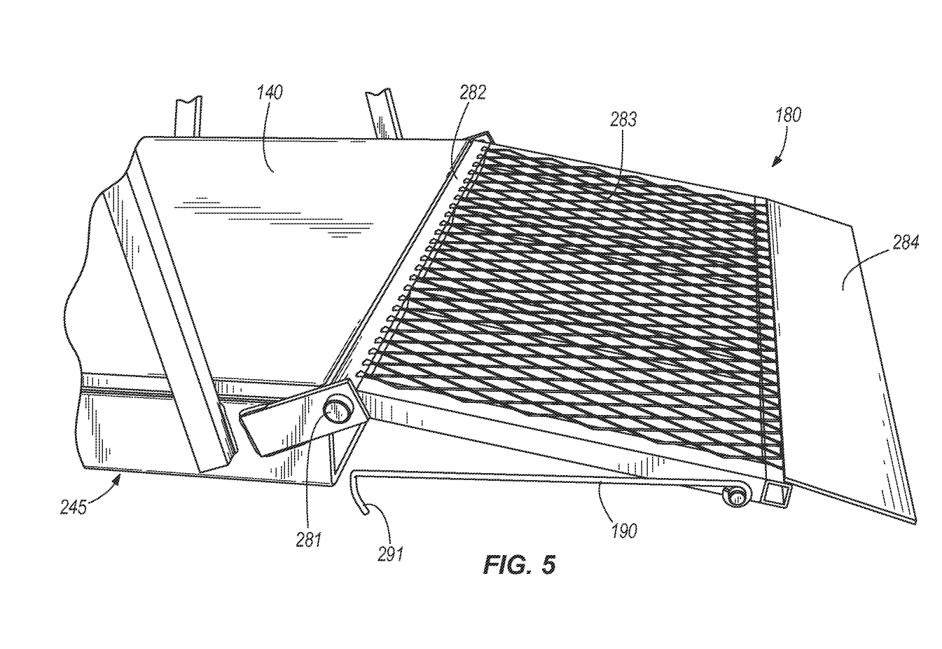

Referring to FIG. 5, the ramp 180 is pivotally mounted to the frame 245 and movable into a deployed condition to facilitate moving the concrete saw 10 onto the pad 140. The ramp 180 includes a hinge 281, a transfer edge 282, a mesh portion 283, and a rigid lip 284. When in a deployed condition (as illustrated in FIG. 5), the rigid lip 284 contacts the ground and the transfer edge 282 is substantially even with the top of the pad 140 to minimize any gap, drop, or step between the ramp 180 and the pad 140. As a result of the minimal gap, the concrete saw 110 is transferred from the ramp 180 to the pad 140 without causing damage to the smooth, hard wheels 20.

Returning to FIGS. 1-3, the ramp 180 is pivotable into a stowed condition in which the ramp 180 is pivoted up. In some embodiments, the ramp 180 is within the footprint of the frame 245 when in the stowed condition. “Within the footprint” means not extending outside of the vertical projection of the frame 245 (i.e., the projection of the frame 245 defined by vertical planes that include the front 210, rear 220, left 230, and right 240 sides of the frame 245).

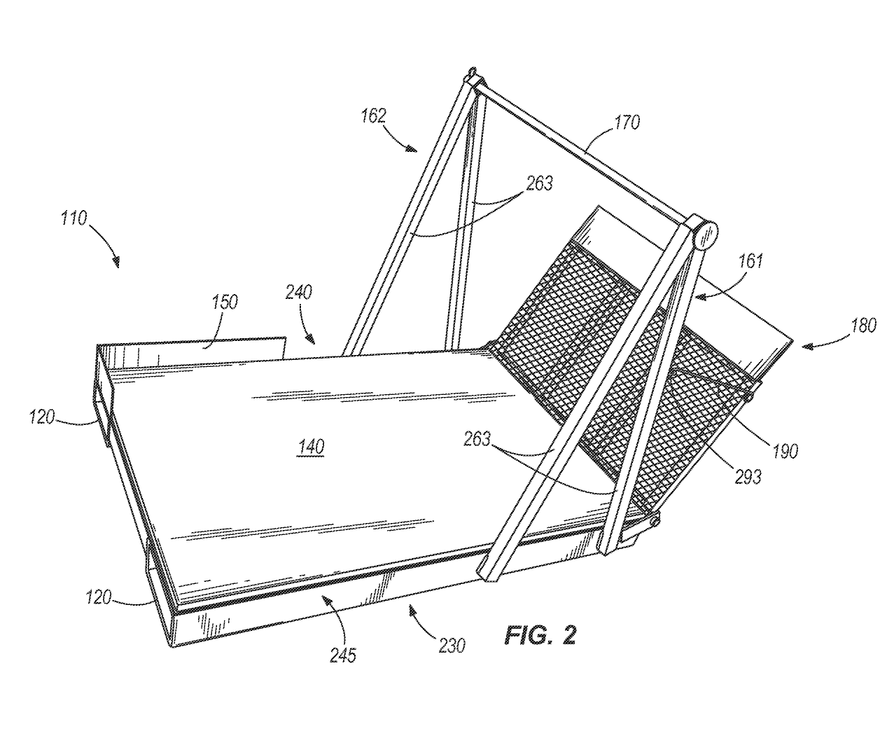

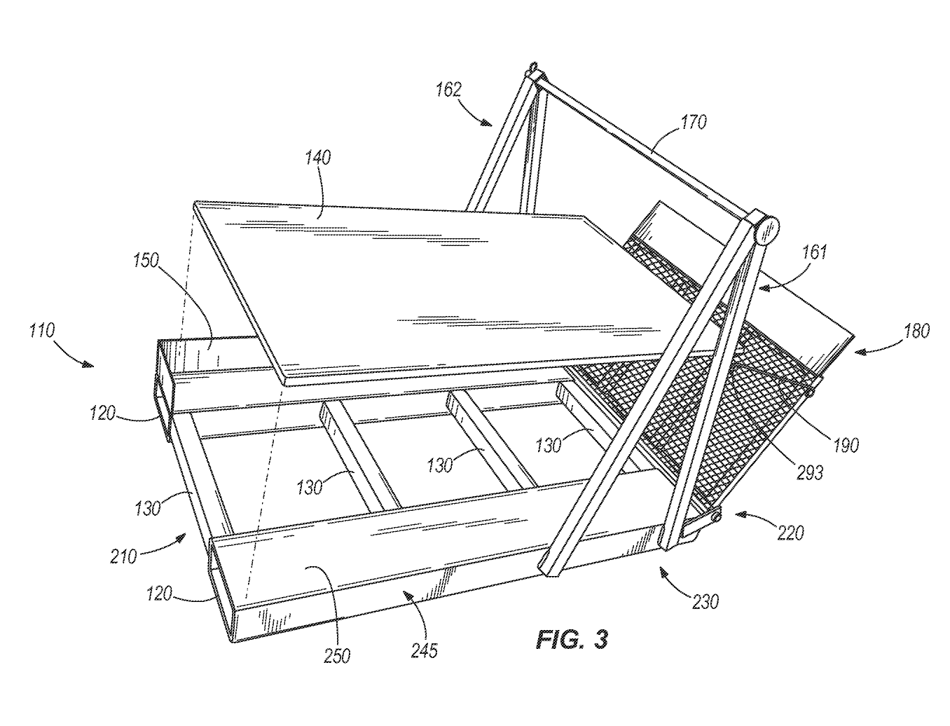

As illustrated in FIG. 5, one end of the latch 190 is pivotally mounted to the ramp 180, and the opposite end of the latch 190 includes a hook 291. The latch 190 can be pivoted to engage the hook 291 in an eye 293 (FIGS. 2 and 3) that is mounted to one of the struts 161, 162. When the hook 291 is received in the eye 293, the latch 190 holds the ramp 180 in the stowed condition.

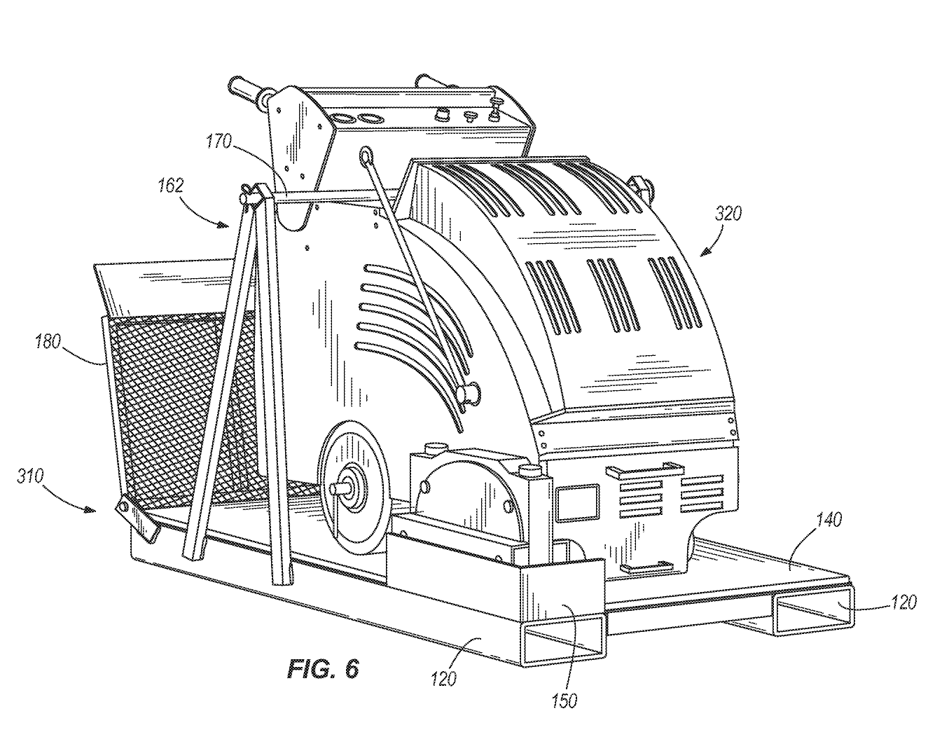

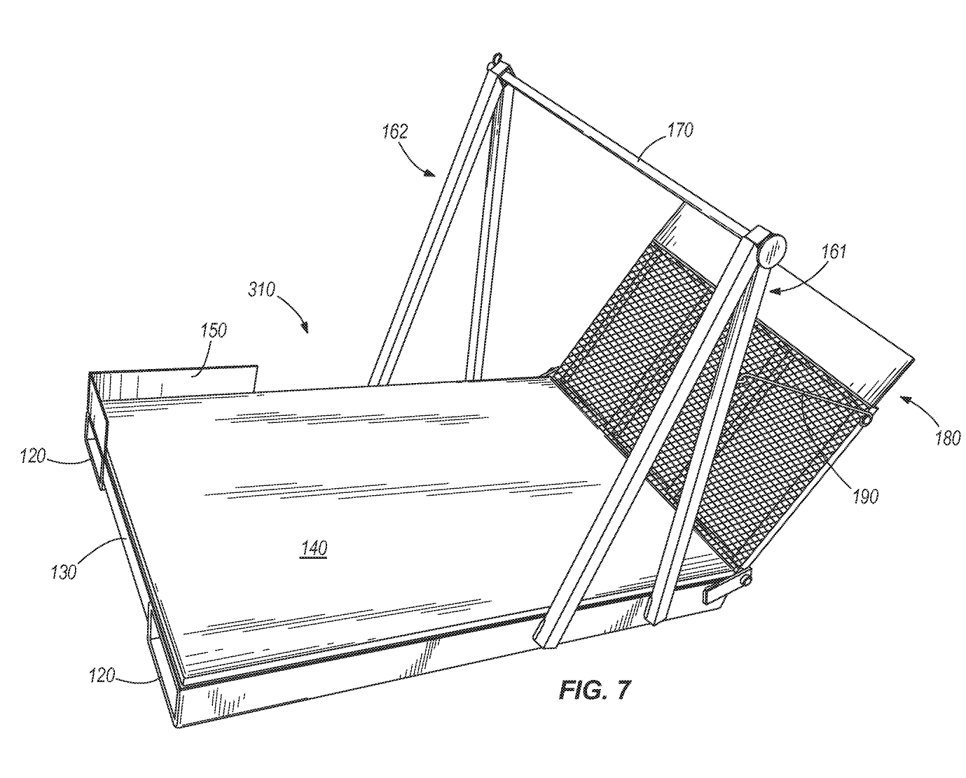

FIGS. 6 and 7 illustrate another embodiment 310 of the transportation rack, but of a larger size to accommodate a larger concrete saw 320. All elements of the embodiment 310 are the same as those of the first embodiment 110, and are labeled as such. In the second embodiment 310, the rack is larger to accommodate the larger concrete saw 320.

With reference to FIG. 8, the transportation system 110 is adapted to be loaded with a lifting device 410 on a transporter 510 for transportation of the saw 10.

In operation, the ramp 180 of an empty transportation rack 110 is unlatched and pivoted into the deployed condition. The transfer edge 282 of the ramp 180 is positioned adjacent to the pad 140 in response to the ramp 180 being in the deployed condition.

The concrete saw 10 is positioned on the transportation rack 110 by rolling the smooth, hard wheel 20 up the ramp 180, across the transfer edge 282, and onto the pad 140 without causing damage to the smooth, hard wheels 20. The pad 140 supports the smooth wheels 20. The precisely-aligned element 130 is proximate the rigid guard 150. The concrete saw 10 is between the support struts 161, 162, such that the support struts 161, 162 are on opposite sides of concrete saw 10.

The rigid bar 170 is extended between the support struts 161, 162 and secured at opposite ends to the support struts 161, 162. If the concrete saw 10 is so configured, the rigid bar 170 may also extend through a portion of the concrete saw 10 (e.g., a tube permanently affixed to the concrete saw 10).

More specifically, the second end of the rigid bar 170 is extended through the apertures 264 on each of the struts 161, 162, such that the rigid bar 170 extends across (or through, as the case may be) a portion of the concrete saw 10 that is on the transportation rack 110. The enlarged knob 271 of the first end of the rigid bar 170 is too large to pass through the aperture 264 of the first support strut 161. The second end of the rigid bar 170 extends beyond the second strut 162 in cantilever fashion. The retaining pin 273 is inserted through the retaining hole 272 in the second end of the rigid bar 170. The retaining pin 273 is wider than the aperture 264 of the second strut 162, such that the retaining pin 273 resists movement of the second end of the rigid bar 170 back through the aperture 264. In this regard, the rigid bar 170 is retained in the installed condition until the retaining pin 273 is removed to enable the rigid bar 170 to be slid out of the apertures 264 of the struts 161, 162.

The rigid bar 170 vertically contains the concrete saw 10 with respect to the frame 245 and limits an amplitude of vertical movement of the concrete saw 10 to limit a dynamic load on the concrete saw 10 arising from transportation of the concrete saw 10.

The rigid bar 170 may apply a containment load on the concrete saw 10 to hold the smooth wheels 20 in constant contact with the pad 140 during transport. The pad 140 absorbs a combination of the containment load and the dynamic load, to the extent such combination exceeds the wheel damage threshold and drive damage threshold, to protect the smooth, hard wheels 20 and drive train 50 from damage.

The ramp 170 is pivoted into the stowed condition, within the footprint of the frame 245, and latched by inserting the hook 281 of the latch 190 on the eye 293.

Then portions of the lifting device 410 are inserted into the first and second tubes 120, the lifting device 410 lifts the transportation rack 110 bearing the concrete saw 10 and deposits it on the transporter 510 for transportation of the concrete saw 10. Straps or other securing members can be used to lash the transportation rack 110 to the transporter 510, such that the load path of the securing members does not apply any load on the concrete saw 10.

The transporter 510 is used to transport the concrete saw 10 to a desired location. During transport, the dynamic loads are generated on the transportation rack 110 and concrete saw 10. The pad 140 absorbs any dynamic loads and any containment load arising during transport or pushing down by the rigid bar 170, to the extent such loads exceed the wheel damage threshold. As a result, the smooth, hard wheels 140 are protected from developing flat spots that would cause the wheels 120 to skip and mar the smooth surface of the green-state concrete being cut.

The rigid guard 150 protects the cutting blade chuck 130 from impacts during transport. In this regard, the rigid guard 150 protects the cutting blade chuck 130 from becoming misaligned as a result of an impact in excess of the misalignment threshold, because the rigid guard 150 absorbs the impact instead of the cutting blade chuck 130.

Once at a desired site, a lifting device 410 can be used to unload the transportation rack 110 bearing the concrete saw 10 so that the concrete saw 10 can be used in its intended environment.

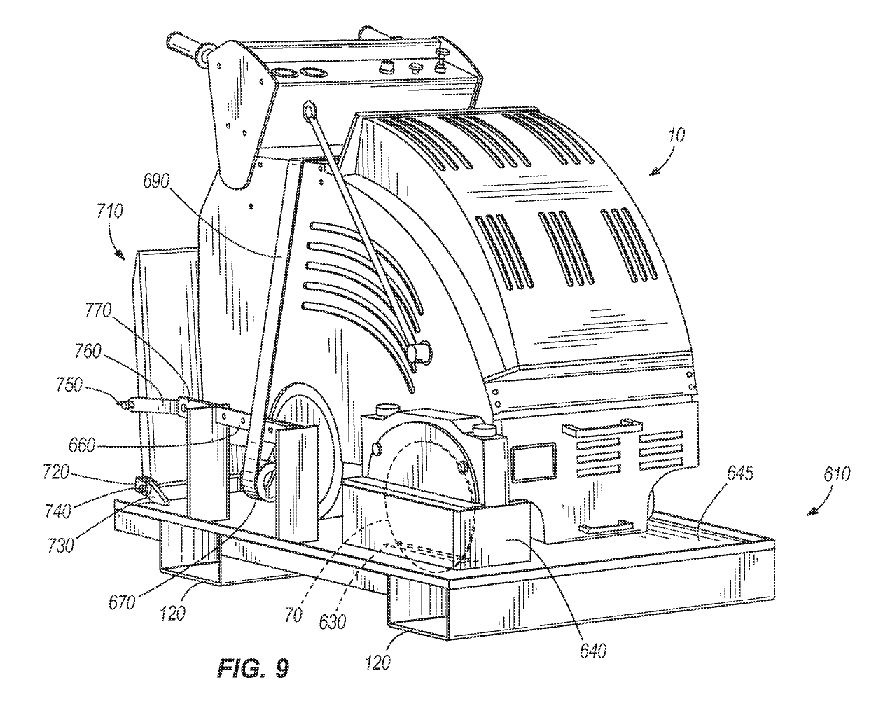

FIGS. 9-13 illustrate a third embodiment 610 of the of the transportation rack. The rack 610 can accommodate multiple sizes of early entry saws 10. Although the drawings illustrate an early entry saw, the third embodiment can accommodate other types of concrete saws and is not limited to early entry saws.

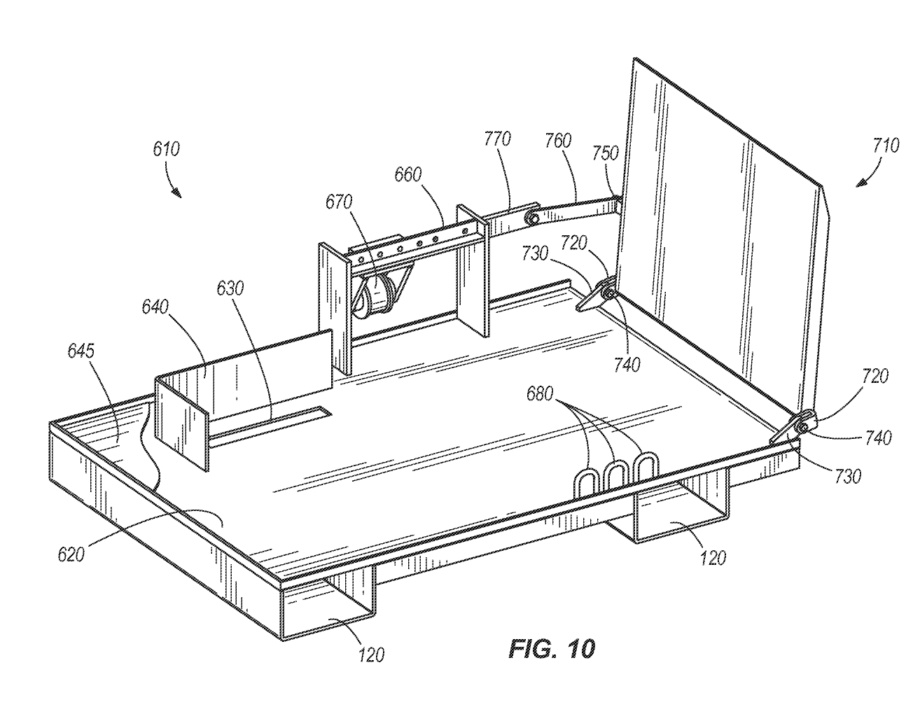

Referring to FIG. 10, the transportation rack 610 includes a support plate 620 having an opening or a slot 630 and a rigid guard 640 proximate the slot 630. A pad 645 sits on top of the support plate 620 to cushion the saw 10, as discussed in the above embodiments. The blade 70 (FIG. 9) of the concrete saw 10 is lowered into the slot 630 once the concrete saw 10 is loaded on the transportation rack 610. The rigid guard 640 is mounted to the support plate 620 along at least a portion of the slot 630 and extends upwardly from the support surface 620. The rigid guard 640 shields the saw blade 70 during trasport. As with other embodiments of the invention, the rack 610 includes a lifting device interface 120 (e.g., fork lift tubes) to faclitate loading the rack 610 on a transporter for transportation of the saw 10. The saw 10 can be transported on the rack 610 with the blade 70 in the operating position (down), which is accommodated by the slot 630.

The transportation rack 610 also includes a mounting bracket 660 for a winch 670, and a plurality of u-bolt anchors 680 on an opposite side from the mounting bracket 660. The mounting bracket 660 and u-bolt anchors 680 are affixed or mounted to the support plate 620.

The winch 670 and a strap 690 may be of a type commercially available from Rack Strap, Inc. (e.g., model RS1). The winch 670 and strap 690 provide a tie-down mechanism that can replace the above-described rigid bar for holding the saw 10 down against the pad. The strap 690 is interconnected to the winch 670 and includes a free end with a hook. The strap 690 is slung across the saw 10 and the hook is connected to a u-bolt anchor 680. Then the strap 690 is tightened down on the saw 10 by actuating the winch 670. The winch 670 applies a tensile load to the strap 690 as the strap engages the saw 10. Several winches 670 and straps 690 can be provided, opposite the several u-bolt anchors 680, to accommodate different positioning of the strap 690 for the various sizes of saws 10 that may be positioned on the rack 610.

The other embodiments of the present invention (e.g., the first embodiment illustrated in FIGS. 1-5 and the second embodiment illustrated in FIGS. 6-7) may incorporate the winch 670 and strap 690 illustrated in FIGS. 9-13, and the embodiment of FIGS. 9-13 can incorporate the support struts 161, 162 and rigid bar 170 of the first and second embodiments of FIGS. 1-8. Any embodiment of the present invention may be provided with the winch 670 and strap 690 arrangement, the support struts 161, 162 and rigid bar 170 arrangement, or both the winch 670 and strap 690 and the support struts 161, 162 and rigid bar 170 arrangement. The winch/strap and struts/bar arrangements, and other arrangements performing the same function, can be generally referred to as restraining mechanisms.

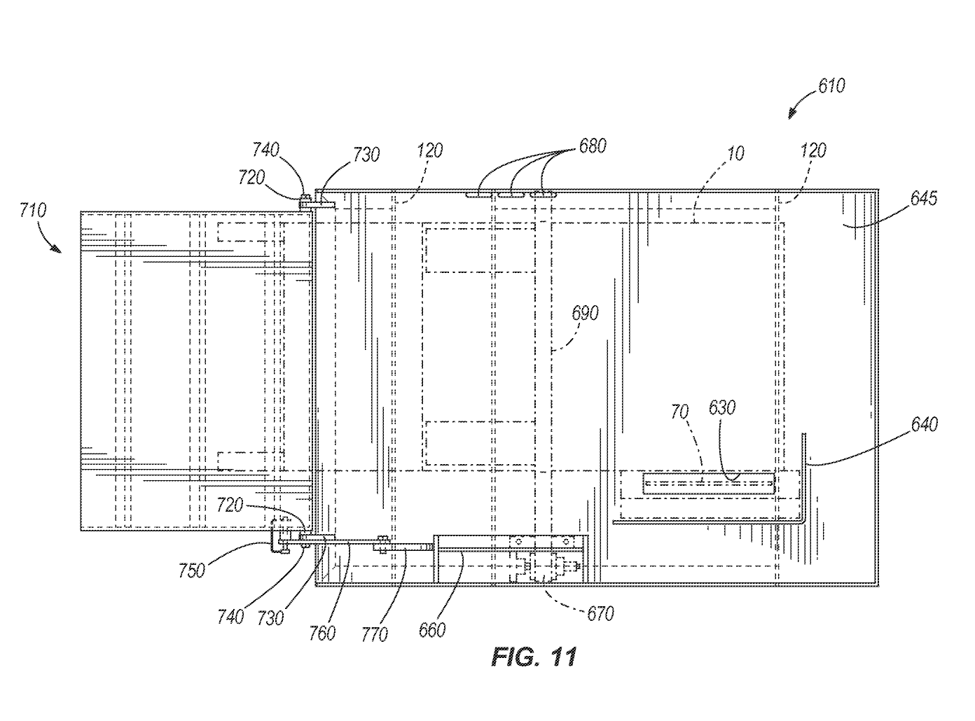

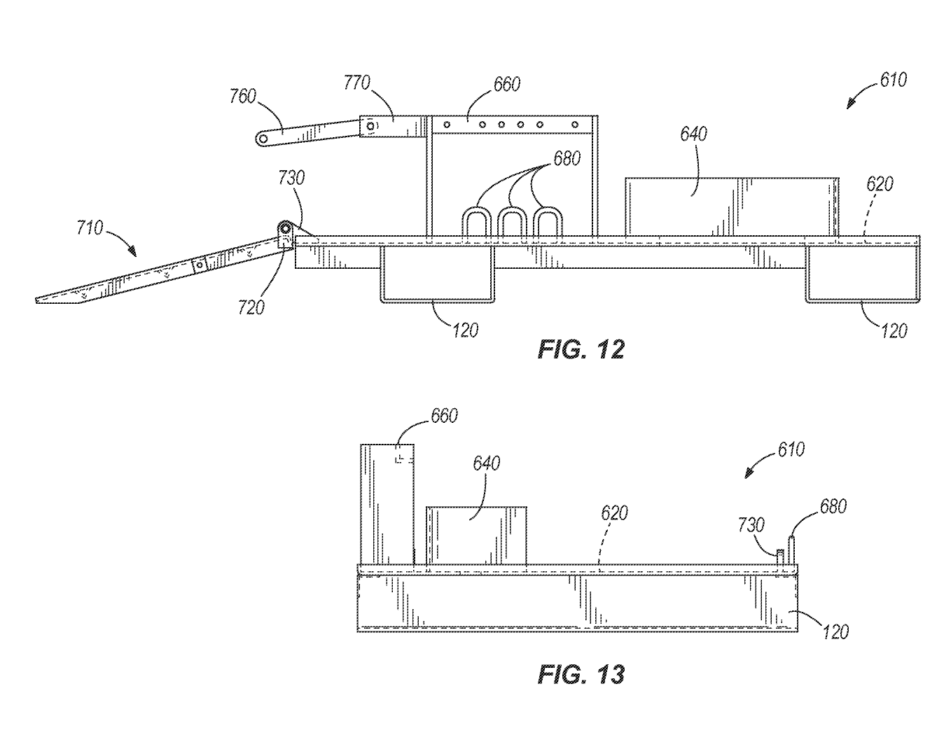

The transportation rack 610 also includes a ramp 710. The ramp 710 includes female clevises 720 on opposite sides. The base plate 620 includes male clevises 730 that are received within the female clevises 720. A hinge pin 740 is extended through holes in the female and male clevises 720, 730. The ramp 710 is pivotally mounted to the frame and movable into a deployed condition (FIGS. 11 and 12) to facilitate moving the concrete saw 10 onto the frame and a stowed condition (FIGS. 9 and 10). The ramp 710 can be held in the stowed condition with a pin 750 and a pivoting bar 760 that is pivotably mounted to an arm 770 that is supported by the bracket 660. The ramp is within the footprint of the frame when in the stowed condition.

Thus, the invention provides, among other things, a transportation rack for securing and transporting construction equipment. Various features and advantages of the invention are set forth in the following claims.

1. A transportation system and concrete saw combination comprising:
a concrete saw including:
at least one wheel for rolling over a concrete surface to be cut, and
a saw blade extending below the at least one wheel and adapted to cut the concrete surface; and
a transportation system including:
a frame including a support surface, and
an opening in the support surface;
wherein the support surface is adapted to support the concrete saw with the wheel on the support surface;
wherein the opening in the support surface is positioned and sized to receive the saw blade while the concrete saw is supported by the support surface; and
wherein the transportation system is adapted to be loaded on a transporter for transportation of the construction equipment.

2. The transportation system and concrete saw combination of claim 1, wherein the at least one wheel of the concrete saw includes a smooth, hard wheel that supports the saw during operation, the transportation system further comprising:
a pad supported by the support surface of the frame and supporting the smooth wheel of the construction equipment, the pad absorbing a dynamic load arising during transport.

3. The transportation system and concrete saw combination of claim 1, further comprising: a rigid guard mounted to the frame along at least a portion of the opening and extending upwardly from the support surface, the rigid guard shielding the saw blade during transport.

4. The transportation system and concrete saw combination of claim 1, further comprising: a restraining mechanism adapted to limit movement of the concrete saw during transport.

5. The transportation system and concrete saw combination of claim 4, wherein the restraining mechanism includes first and second support struts mounted to the frame on opposite sides of the frame and adapted to extend upwardly on opposite sides of the concrete saw, and a rigid bar extending between the support struts.

6. The transportation system and concrete saw combination of claim 4, wherein the restraining mechanism includes a strap having at least one end anchored to the frame.

7. The transportation system and concrete saw combination of claim 6, wherein the strap includes an opposite end also anchored to the frame, the strap extending across the concrete saw.

8. The transportation system and concrete saw combination of claim 6, wherein the restraining mechanism also includes a winch acting on the strap.

9. The transportation system and concrete saw combination of claim 6, wherein the frame includes an anchor and the strap includes a hook for engaging the anchor.

10. The transportation system and concrete saw combination of claim 1, further comprising a ramp pivotally mounted to the frame and movable into a deployed condition to facilitate moving the concrete saw onto the frame and a stowed condition; male and female clevises on the frame and ramp; and a hinge pin extending through the male and female clevises to pivotally mount the ramp to the frame.

11. The transportation system and concrete saw combination of claim 10, wherein the ramp is within the footprint of the frame when in the stowed condition.

12. The transportation system and concrete saw combination of claim 1, further comprising a lifting device interface adapted to receive portions of a lifting device to facilitate loading and unloading the transportation system onto and off of the transporter.

13. The transportation system and concrete saw combination of claim 12, wherein the lifting device interface includes a pair of fork lift tubes.
